(19) United States
(12) Patent Application Publication
(10) Pub. No.: US 2004/0093933 A1
(43) Pub. Date: May 20, 2004

(54) Sample collection vessel extender for chromatographic systems

(76) Inventors: Terry A. Berger, Englewood, FL (US); Kenneth J. Klein, Newark, DE (US); Kimber D. Fogelman, Hockessin, DE (US); Vincent L. Worley, Wilmington, DE (US)

Correspondence Address: ZITO TLP, 26005 RIDGE ROAD, SUITE 203, DAMASCUS, MD, 20872, US

(21) Appl. No.: 10/705,907

(22) Filed: Nov. 13, 2003

Related U.S. Application Data
(60) Provisional application No. 60/425,627, filed on Nov. 13, 2002.

(51) Int. Cl. G01N 30/80

(52) U.S. Cl. 73/61.55

(57) ABSTRACT

A mobile phase collection device for increasing the total collectible volume of a liquid fraction that is collected in supercritical fluid chromatography or liquid chromatography includes a collection vessel assembly that is suitable for increasing the total collectable volume of a liquid phase fraction while using a relatively smaller collection vessel. A vessel extender is attached to an attachment end of a relatively smaller collection vessel, resulting in the ability to increase the total volumetric size of a collection vessel. The extended vessel assembly can be used throughout an entire purification and dry down process.

### STATEMENT OF PRIORITY

This application claims the benefit of related application No. 60/425,627, filed on Nov. 13, 2002.

### FIELD OF THE INVENTION

The invention relates to sample fraction collection in chromatography. Exemplary embodiments relate to increasing the total collectible volume of a liquid fraction collected into a single collection vessel in preparatory scale supercritical fluid chromatography or preparatory scale liquid chromatography.

### BACKGROUND OF THE INVENTION

A substantial need exists for industries to recover purified components of interest from samples containing simple or complex mixtures of components. Many technologies have been developed to meet this need. For dissolvable, nonvolatile components, the technology of choice has been liquid elution chromatography.

Analysts have several objectives in employing preparative elution chromatography. First, they wish to achieve the highest available purity of each component of interest. Second, they wish to recover the maximum amount of the components of interest. Third, they wish to process sequential, possibly unrelated samples as quickly as possible and without contamination from prior samples. Finally, it is frequently desirable to recover samples in a form that is rapidly convertible either to the pure, solvent-free component or to a solution of known composition which may or may not include the original collection solvent.

In the case of normal phase chromatography, where only organic solvents or mixtures are used as eluants, typical fraction volumes of tens to hundreds of millimeters are common. The fraction must then be evaporated over substantial time to recover the component residues of interest. In reversed phase chromatography, where mixtures of organic solvents and water are used as the elution mobile phase, a secondary problem arises. After removal of lower boiling solvents, recovered fractions must undergo a water removal step lasting from overnight to several days. Thus, availability of the recovered components of interest is delayed by hours or days, even after the separation process is complete. This latter problem can create a serious bottleneck in the entire purification process when enough samples are queued.

Where difficult separation conditions exist or separation speed is a requirement, a subset of elution chromatography, known as high performance liquid chromatography (HPLC), is preferred. This HPLC technique is used both as an analytical means to identify individual components and as a preparative means of purifying and collecting these components.

For analytical HPLC, samples with component levels in the nanogram to microgram range are typical. Preparative HPLC systems typically deal with microgram to multiple gram quantities of components per separation. Preparative HPLC systems also require a means to collect and store individual fractions. This is commonly performed, either manually or automatically, simply by diverting the system flow stream to a series of open containers. Drawbacks exist to the current use of preparative HPLC. Elution periods ranging from several minutes to hours are necessary for each sample. Further, even in optimal conditions only a small fraction of the mobile phase contains components of interest. This can lead to very large volumes of waste mobile phase being generated in normal operation of the system.

An alternative separation technology called supercritical fluid chromatography (SFC) has advanced over the past decade. SFC uses highly compressible mobile phases, which typically employ carbon dioxide (CO2) as a principle component. In addition to CO2, the mobile phase frequently contains an organic solvent modifier, which adjusts the polarity of the mobile phase for optimum chromatographic performance. Since different components of a sample may require different levels of organic modifier to elute rapidly, a common technique is to continuously vary the mobile phase composition by linearly increasing the organic modifier content. This technique is called gradient elution.

SFC has been proven to have superior speed and resolving power compared to traditional HPLC for analytical applications. This results from the dramatically improved diffusion rates of solutes in SFC mobile phases compared to HPLC mobile phases. Separations have been accomplished as much as an order of magnitude faster using SFC instruments compared to HPLC instruments using the same chromatographic column. A key factor to optimizing SFC separations is the ability to independently control flow, density and composition of the mobile phase over the course of the separation.

SFC instruments used with gradient elution also reequillibrate much more rapidly than corresponding HPLC systems. As a result, they are ready for processing the next sample after a shorter period of time. A common gradient range for gradient SFC methods might occur in the range of 2% to 60% composition of the organic modifier.

SFC instruments, while designed to operate in regions of temperature and pressure above the critical point of CO2, are typically not restricted from operation well below the critical point. In this lower region, especially when organic modifiers are used, chromatographic behavior remains superior to traditional HPLC and often cannot be distinguished from true supercritical operation.

In analytical SFC, once the separation has been performed and detected, the highly compressed mobile phase is directed through a decompression step to a flow stream. During decompression, the CO2 component of the mobile phase is allowed to expand dramatically and revert to the gas phase. The expansion and subsequent phase change of the CO2 tends to have a dramatic cooling effect on the waste stream components. If care is not taken, solid CO2, known as dry ice, may result and clog the waste stream. To prevent this occurrence, heat is typically added to the flow stream. At the low flow rates of typically analytical systems only a minor amount of heat is required.

While the CO2 component of the SFC mobile phase converts readily to a gaseous state, moderately heated liquid organic modifiers typically remain in a liquid phase. In general, dissolved samples carried through SFC system also remain dissolved in the liquid organic modifier phase.

The principle that simple decompression of the mobile phase in SFC separates the stream into two fractions has great importance with regard to using the technique in a preparative manner. Removal of the gaseous CO2 phase, which constitutes 50% to 95% of the mobile phase during normal operation, greatly reduces the liquid collection volume for each component and thereby reduces the post-chromatographic processing necessary for recovery of separated components, as well as greatly shortening dry-down time.

A second analytical purification technique similar to SFC is supercritical fluid extraction (SFE). Generally, in this technique, the goal is to separate one or more components of interest from a solid matrix. SFE is a bulk separation technique, which does not necessarily attempt to separate individually the components, extracted from the solid matrix. Typically, a secondary chromatographic step is required to determine individual components. Nevertheless, SFE shares the common goal with prep of SFC of collecting and recovering dissolved components of interest from a supercritical flow stream. As a result, a collection device suitable for preparative SFC is suitable for SFE techniques.

Expanding the technique of analytical SFC to allow preparative SFC requires several adaptations to the instrument. First the system requires increased flow capacity. Flows ranging from 20 ml/min to 200 ml/min are suitable for separation of multi-milligram up to gram quantities of materials. Also, a larger separation column is required. Finally, a collection system must be developed that will allow, at a minimum, collection of a single fraction of the flow stream which contains a substantially purified component of interest. In addition, there frequently exists a compelling economic incentive to allow multiple fraction collections from a single extracted sample. The modified system must also be able to be rapidly reinitialized either manually or automatically to allow subsequent sample injection followed by fraction collection.

Several commercial instances of preparative SFC instrumentation have been attempted which have employed different levels of technology to solve the problems of collection. A representative sampling of these products includes offerings from manufacturers such as Gilson, Thar, Novasep, and ProChrome. However, no current implementation succeeds in providing high recovery, high purity, and low carryover from sample to sample. For example, one system may use the unsophisticated method of simply spraying the collection stream directly into a large bottle, which results in high sample loss, presumably due to aerosol formation. Another system uses a cyclonic separator to separate the two streams, but provides no rapid or automated means of washing the separators to prevent carryover. Such instruments are typically employed to separate large quantities of material by repetitive injection so that no sample-to-sample cleaning step is required. Other systems use a collection solvent to trap a sample fraction into a volume of special solvent in a collection container. This technique uses relatively large quantities of hazardous solvents to perform sample collection, is prone to sample fraction concentration losses or degradation, and possible matrix interferences exist between fractionated samples and collection solvent constituents.

In some cases in the collection of liquid fractions from specific sample peaks in SFC, very large amounts of liquid are typically required for collection although this amount is far less than that required for HPLC due to both much narrower peak widths and the venting of 50-95% of the CO2. Collection into a single standardized collection vessel becomes a problem when the vessel holds less volume than is separated from a peak of interest and the vessel overfills with fractions. Prior methods for collecting a broad large-volume peak include truncating the collection prior to overfilling the available volume of the collection vessel or continuing to collect the fraction using a series of up to “n” number of unspecified collection vessels, which in further steps is dried down and recombined. Therefore, what is highly desirable is an automated assembly to collect all of the solvent and solute mixture from a fraction into a single collection vessel in the majority of cases.

### SUMMARY

There is described herein a preferred exemplary embodiment of an extended vessel assembly to that provides collection of substantially large volumes of liquid fractions from chromatography system, such as a preparatory scale supercritical fluid chromatography (“Prep Scale SFC”) or preparatory scale liquid chromatography (“Prep Scale LC”), into a single collection vessel having a volume smaller than the fraction collected from a peak. The invention allows a collection system to collect all of the solute/solvent mixture in a fraction into the extended vessel assembly, thereby collecting a substantially larger liquid volume than the collection vessel itself can retain.

The vessel extender of the extended vessel assembly is suitable for increasing the total collectable volume of a liquid phase fraction from Prep Scale SFC or Prep Scale LC while using a relatively small collection vessel. The final collection vessel can be used throughout the entire purification and dry down process, including the final stages of re-solvating in dimethyl sulfoxide (“DMSO”) and storage. The invention improves productivity while reducing the need for sample transfer between vessels and reducing the risk of human error. The device of the preferred embodiment enables the use of a single collection/storage vessel to collect and hold a significantly larger liquid volume than the available volume of the vessel itself. In SFC, this additional volume allows for expansion of CO2 without disturbing the surface of liquid to the point of aerosol formation. The additional liquid volume is then reduced after purification collection using one of several types of evaporation devices or techniques, such as evaporation at moderate temperature under a vacuum with liquid agitation to minimize bumping.

The vessel extender can be applied to a range of vessel types and sizes. For example, a 1 Dram (4 mL) screw-cap vessel is a common vessel for final storage of purified, dried down, weighed compound which is then re-solvated in DMSO, capped and stored into a Compound Library Storage System. For such a 1 Dram screw-cap vessel, the vessel extender screws down snugly onto the vessel, forming a sealing or “near-sealing” contact onto a collection vessel. Further embodiments of the vessel extender can snap on to a crimp cap vessel or form an “interference fit” on the inner or outer diameter of a straight-walled collection vessel, such as a test tube. In such a way, the possible collectable volume of liquid can be substantially greater (by as much as an order of magnitude or more) than the volume of the collection vessel itself.

The present invention greatly reduces the amount of hazardous solvents purchased, used, and disposed of by an analytical chemistry laboratory. Historically, disposal of spent solvents have created many environmental problems in the United States and other nations. Solvents, such as methylene chloride, are typically purchased and used in many analytical laboratory methods to extract constituents of interest from a sample. HPLC typically uses acetonitrile in water, which typically must be disposed of by energy-intensive incineration. Other laboratory methods, such as some of those used in supercritical chromatography, use chemicals such as methanol as part of the analytical method. Laboratories using these chemicals not only release solvent vapors into the ambient air, but also generate up to hundreds of gallons of spent solvents per month. Disposal of these spent solvents is often more expensive than purchasing the same solvents. The present invention uses no solvents to collect and trap a sample in a collection vessel, thereby eliminating the generation of large quantities of spent solvent to extract a sample. This not only cuts down on solvent contamination of the ambient air in a laboratory but also disposal problems in landfills and incinerators.

### BRIEF DESCRIPTION OF THE DRAWINGS

For a better understanding of the nature of the present invention, reference is had to the following figures and detailed description, wherein like elements are accorded like reference numerals, and wherein:

FIG. 1 is a flow diagram of a supercritical fluid chromatography system;

FIG. 2 is a cross-sectional view of an extended vessel assembly using screw-cap extender for attachment;

FIG. 3 is a cross-sectional view of an extended vessel assembly with a restriction at the top end;

FIG. 4 is a cross-sectional view of an extended vessel assembly using a flange ring on the vessel extender for attachment to a collection vessel;

FIG. 5 is a cross-sectional view of an extended vessel assembly using a housing around a collection vessel for attachment.

### DETAILED DESCRIPTION OF PREFERRED EMBODIMENTS

There is described herein a preferred embodiment of the present invention for an extended vessel assembly for increasing the total collectable volume of a liquid fraction separated from a sample injection into a chromatography system. The preferred embodiment may be implemented in chromatography systems that include supercritical fluid chromatography (“SFC”), such as preparatory scale (prep) or analytical SFC, and liquid chromatography (LC) such as preparatory scale LC or high performance liquid chromatography (HPLC). The present invention teaches a sample fraction collection and storage device that is used throughout the entire collection, purification, and dry down processes of a sample fraction, including the final stages of re-solvation and storage.

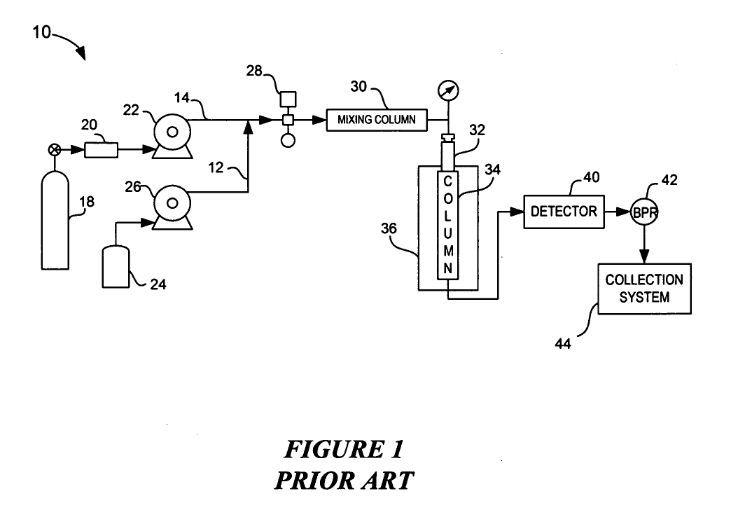

Components of an SFC system 10, upstream of a collection system, are illustrated in the schematic of FIG. 1. System 10 comprises two independent flow streams 12, 14 combining to form the mobile phase flow stream. In a typical SFC pumping assembly, a compressible fluid, such as carbon dioxide (CO2), is pumped under pressure to use as a supercritical solvating component of a mobile phase flow stream. Tank 18 supplies CO2 under pressure that is cooled by chiller 20. Due to precise pumping requirements, SFC systems commonly use an SFC-grade reciprocating piston pump 22 having dynamic compressibility compensation.

A second independent flow stream in the SFC system provides modifier solvent, which is typically methanol but can be a number of similar solvents suitable for use in SFC. Modifier is supplied from a supply tank 24 feeding a second high-grade pump for relatively incompressible fluids 26. Flow is combined into one mobile phase flow stream and passes through pressure regulator 28 prior to entering mixing column 30. The combined mobile phase is pumped at a controlled mass-flow rate from the mixing column 30 through transfer tubing to a fixed-loop injector 32 where a sample is injected into the flow stream.

The flow stream, containing sample solutes, then enters a chromatography column 34. Column 34 contains stationary phase that elutes a sample into its individual constituents for identification and analysis. Temperature of the column 34 is controlled by an oven 36. The flow rate should be kept as constant as possible through the separation column. If the flow rate fluctuates, variations in the retention time of the injected sample would occur such that the areas of the chromatographic peaks produced by a detector connected to the outlet of the column would vary. Since the peak areas are representative for the concentration of the chromatographically separated sample substance, fluctuations in the flow rate would impair the accuracy and the reproducibility of quantitative measurements. At high pressures, compressibility of solvents is very noticeable and failure to account for compressibility causes technical errors in analyses and separation in SFC.

The elution mixture leaving column 34 passes from the column outlet into detector 40. Detector 40 can vary depending upon the application, but common detectors are ultraviolet, flame ionization (with an injector- or post-column split), or mass spectrometry. After analysis through the detector 40, the mobile phase flow stream passes through a back-pressure regulator 42, which leads to a downstream sample fraction phase separation and collection system 44. The collection system 44 includes the equipment and processes for collecting liquid phase fractions from a mobile phase flow stream into a final collection vessel.

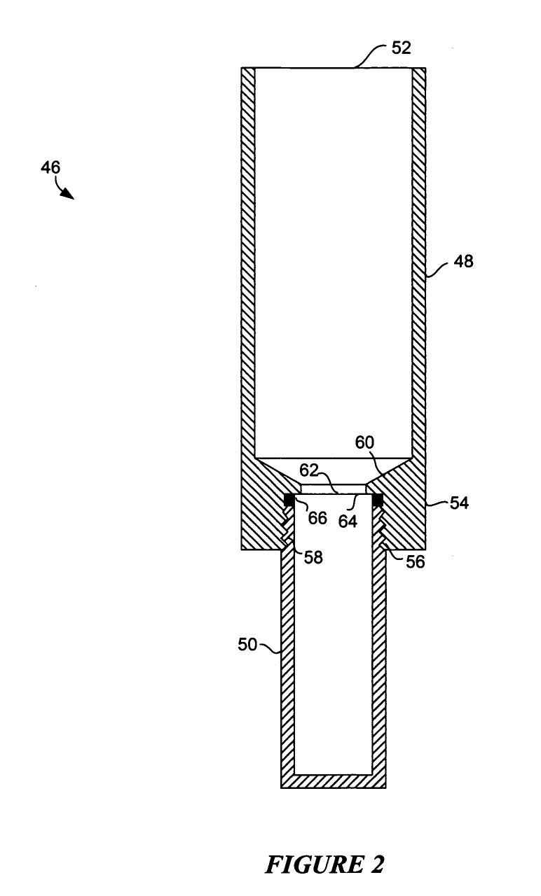

Reference is made to FIG. 2, illustrating a cross-sectional view of a preferred exemplary embodiment of an extended vessel assembly (EVA) 46. The vessel extender 48 attaches to a collection vessel 50 for collection of a wide dynamic range of fractions from peaks of chromatographically separated sample substances while using the same footprint as a single collection vessel. Vessel extender 48 is a generally hollow cylindrical vessel that receives liquid phase from a collection system 44 through the mouth 52 in the top end with a bottom end 54 designed for attaching to a collection vessel 50. Vessel extender 48 has female threads 56 at the attaching end for reception of male screw-cap threads 58 of collection vessel 50. While the exterior of the vessel extender 48 at the attaching end 54 retains its cylindrical shape, the interior 60 has a funnel-shaped reduced diameter so that liquids received from a sample fraction collection system 44 are directed into the relatively smaller volume collection vessel 50. The mouth 62 of the vessel extender at the bottom attaching 54 end may have the same or smaller inner diameter (ID) as the mouth at the top, screw-cap end 64 of the collection vessel 50. However, an equal ID of the two mouths 62, 64 creates a smooth-flowing stream and minimizes problems with a restriction between the two pieces and turbulence in the collection vessel 50.

In a preferred exemplary embodiment, a collection vessel 50 is a 1-Dram (4 mL) screw-cap vessel that is commonly used in prep SFC for sample collection and storage. As one skilled in the art will recognize, the sizes and shapes of EVAs are exemplary and exact sizes, shapes, and structures of EVAs and collection vessels may vary without exceeding the scope of the inventive concept taught herein. In FIG. 2, a vessel extender 48 is attached on top of collection vessel 50. The bottom end 54 of a vessel extender 48 screws onto the top end 64 of a collection vessel 50 which forms a liquid-proof seal. The resulting EVA 46 provides for temporary filling of the collection vessel 50 beyond the volume of the collection vessel itself

When collecting a purified compound by Prep SFC or Prep LC, the collection of a total peak into a single collection vessel may not be possible. This is typically the case when collecting a broad solute peak at a relatively late point in a gradient elution by Prep SFC. At a 40% to 50% ratio of modifier to compressible fluid flow in a Prep SFC mobile phase flow stream operating at 50 mL/min, a 1 minute wide peak would collect approximately 20 to 25 mL of liquid volume. At these gradient conditions, a peak that is ½ or ¼ minute wide will result in a collection volume of approximately 5 to 13 mL of liquid volume, all exceeding the capacity of a single 1 Dram (4 mL) collection vessel. Using a vessel extender 48 and collection vessel 50 that are appropriately sized for the type of chromatography, liquid phase from an entire chromatographic peak may be collected into a single EVA 46. For example, compared to collection vessel 50 the volume of liquid phase fractions that can be collected is expanded by a factor of ten, making it possible for a 4 mL vessel to temporarily hold up to 40 mL of liquid, with an appropriately-sized vessel extender 48.

The connection between a collection vessel 50 and a vessel extender 48 should seal liquids sufficiently to contain the liquid held in the EVA 46. The sealing contact should be adequate to minimize solvent/solute leakage out of the assembly when filled with liquid beyond the capacity of the collection vessel 46. The exemplary EVA 46 in FIG. 2 has female threads 56 that receive the male threads 58 on collection vessel 50. A seal 66 can be optionally added to the vessel extender to fit against the collection vessel 50 when engaged with vessel extender 48. Various sealing mechanisms can provide an appropriate seal. A sealing surface could rely on an elastomeric O-ring or gasket, a semi-compliant gasket such as a polytetrafluoroethylene (PTFE) disc or seal, or on a direct seal between the vessel extender 48 and the collection vessel 50 surfaces. When implementing the assembly with an elastomeric seal, it is important that such a material be selected that will be inert and compatible in the solvent/solute environment to which it is exposed.

A vessel extender 48 could be designed as a single-use throwaway consumable or designed for multiple uses. If vessel extender 48 is designed for single or few uses or designed for applications that will infrequently fill the collection vessel 50 beyond its volumetric capacity, then addition of an elastomeric seal is merely optional. In such cases, the vessel extender 48 is designed to either directly form a seal to the collection vessel surface or seal with an intermediate, consumable “compliant seal disc” constructed of chemically inert and resistant materials such as PTFE or PEEK. Further designs of a consumable compliant seal include a chevron and ferrule type seal.

The vessel extender 48 of the preferred embodiment may be fabricated from an inert plastic material, preferably a material that is not significantly hydroscopic and one amenable to injection molding into final form without compromising other material properties of the extender. Possible materials for fabrication of the vessel extender include PTFE, Victrex PEEK polymer (PEEK), polypropylene, polyethylene, and polyurethane. The fabrication material and process should be carefully selected such that material or process fabrication contaminants, such as mold release, do not jeopardize the use of the vessel extender as part of a purification system. Vessel extenders may be fabricated with special chemical processes or surface treatments and coatings prior to use in the collection system 44 to ensure the highest possible inertness.

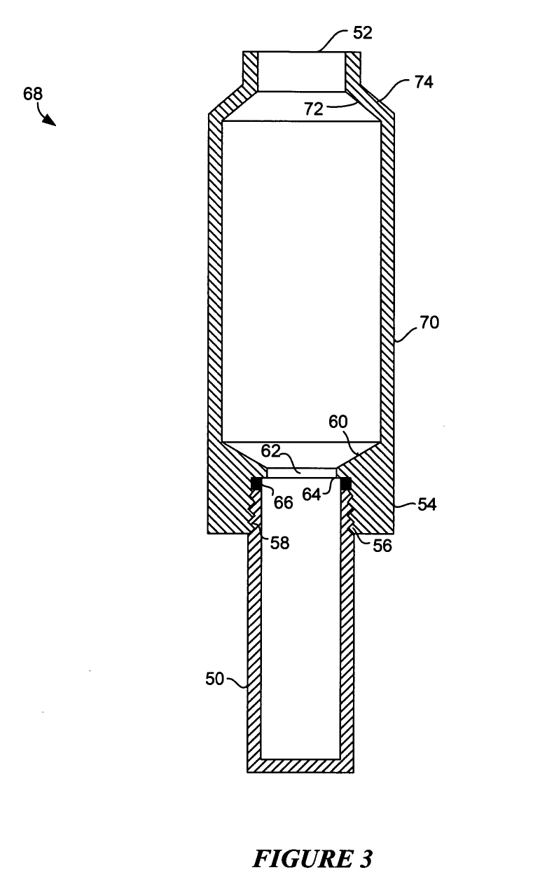

Alternative embodiments of the extended vessel assembly are illustrated in FIGS. 3, 4, and 5. A cross-sectional view of an alternative embodiment of an EVA 68 is illustrated in FIG. 3. The vessel extender 70 of the alternative embodiment is a generally hollow cylindrical vessel that receives liquid phase from the collection system 44 through the top receiving end 52 with a bottom end 54 designed for attaching to collection vessel 50. The top, receiving end 52 of the alternative vessel extender has a funnel-shaped reduced diameter on the interior 72 and exterior 74 of the vessel extender. This shape provides adequate space for flow into the vessel extender 70 from a collection system 44 and for a robotic arm or other automated device to reach into a tightly-packed rack of EVAs 68 and grab the top end of the vessel extender 52 without contacting vessel extenders of neighboring EVAs. Vessel extender 70 has female threads 56 at the attaching end 54 for reception of male screw-cap threads 58 of collection vessel 50. While the exterior of the vessel extender 70 at the attaching end 54 retains its cylindrical shape, the interior has a funnel-shaped reduced diameter 60 so that liquids received into the top end 52 from a sample fraction collection system 44 are directed into the relatively smaller volume collection vessel 50. The mouth of the vessel extender 62 at the bottom attaching end 54 may have the same or smaller ID as the mouth 64 of collection vessel 50. However, an equal ID of the two mouths 62, 64 creates a smooth-flowing stream and minimizes problems with a restriction between the two pieces and turbulence in the collection vessel 50.

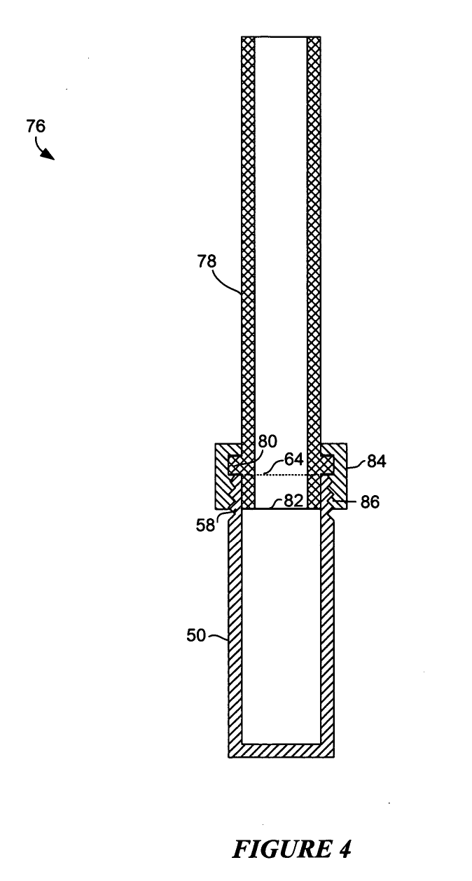

FIG. 4 illustrates a cross-sectional view of an alternative exemplary embodiment of an EVA 76. Vessel extender 78 is generally hollow and has a cylindrically shaped interior and cylindrical exterior except for an external flange 80 on the outside of the extender near the attachment end. Vessel extender 78 attaches to a collection vessel 50 with a female threaded coupling 84 which secures flange ring 80 and male threads 58. Coupling 84 holds flange 80 securely in a groove and screws onto the collection vessel's male threads 56 with female threads 86 until rim of mouth 64 abuts the bottom of flange 80. Once attached, mouth 82 of the vessel extender 78 extends into the collection vessel 50 but is stopped by the bottom of flange 80 contacting the top rim 64 of collection vessel 50. The EVA 76 in FIG. 4 has an axial cross-sectional area only slightly larger than the collection vessel 50 itself, which allows a greater packing density of EVAs 76 into a rack or other storage unit.

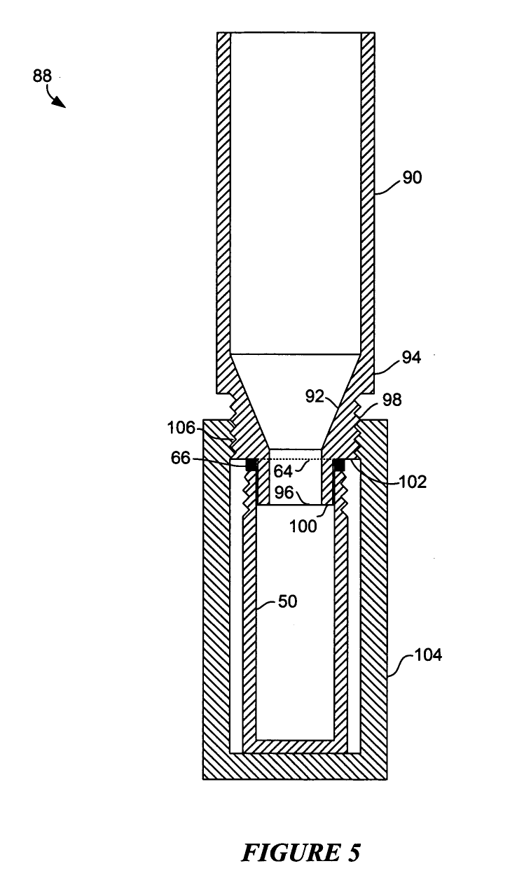

FIG. 5 illustrates a cross-sectional view of an additional embodiment of an EVA 88 secured with an interference fit on the inner or outer diameter of a straight-walled collection vessel 50. The interior of the vessel extender 90 is funnel-shaped 92 at the attaching end 94 so that liquids from a collection system 44 can be directed into a relatively smaller collection vessel 50. The vessel extender 90 is generally cylindrical and has a tiered outer profile at the attachment end 94. A first tier has a series of male threads 98. The second tier 100 is smooth and forms the mouth 96 of the vessel extender 90. Vessel extender mouth 96 should have a smaller outer diameter than the ID of collection vessel mouth 64 because vessel extender mouth 96 extends into the collection vessel 50. Collection vessel mouth 96 is stopped by flanged surface 102 contacting the rim of collection vessel mouth 64.

The collection vessel 50 is held inside of a housing 104 that is closed on all sides except the top attaching end 108. The attaching end 108 of the housing 104 has a series of internal female threads 106 that form a threaded seal when the housing 104 receives the male threads 98 on first tier of the vessel extender 90. Seal 66 may be placed between the top rim of a collection vessel mouth 64 and below the first tier flanged surface 102. The sealing contact should be adequate to minimize or prevent solvent/solute leakage out of the EVA 88 when filled with liquid beyond the capacity of the collection vessel 50.

The alternative embodiment comprising a housing 104 has a broader application for attaching a vessel extender 90 to collection vessel 50 because the extender 90 can work with any collection vessel 50 that is suitable for liquid fraction collection in an SFC or LC system, for example a test tube or larger capacity bottle (not shown).

The present invention is well suited for use in liquid or supercritical preparatory scale chromatography systems that separate and collect liquid phase fractions. As one skilled in the art will recognize, the invention may be used in any chromatography system where it is necessary retain a high percentage of sample fractions from an injected sample into a collection vessel. The invention improves productivity while reducing the need for sample transfer between vessels and reducing the risk of human error.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. An sample collection vessel assembly for chromatographic systems, comprising:
a vessel extender, attached to a collection vessel, so that a mobile phase flow stream enters the vessel extender and fills the collection vessel,
wherein the vessel extender provides a volumetric capacity to hold the mobile phase flow stream beyond the volumetric capacity of the collection vessel.

2. The collection vessel assembly of claim 1, wherein the vessel extender comprises a mouth at an attachment end of the vessel extender meets a mouth at an attachment end of the collection vessel to provide a flow path for the mobile phase flow stream to enter the collection vessel.

3. The collection vessel assembly of claim 1, wherein the vessel extender sealably attaches to the collection vessel with a threaded connection.

4. The collection vessel assembly of claim 1, wherein the vessel assembly sealably attaches to the collection vessel with an external coupling.

5. The collection vessel assembly of claim 4, wherein the external coupling attaches to an external flange on an attachment end of the vessel extender and attaches to an attachment end of the collection vessel.

6. The collection vessel assembly of claim 5, wherein a mouth of the vessel extender extends into the collection vessel until the external flange contacts the mouth the collection vessel.

7. The collection vessel assembly of claim 1, further comprising:
a housing, holding the collection vessel within the housing, that attaches to the vessel extender at an attachment end to provide a flow path for the mobile phase flow stream to enter the collection vessel from the vessel extender.

8. The collection vessel assembly of claim 1, wherein the vessel extender comprises an attachment end to receive an attachment end of the collection vessel, and
the vessel extender comprises an extended mouth that protrudes into the collection vessel.

9. The collection vessel assembly of claim 1, wherein the vessel extender comprises a cylindrical body with a reduced-diameter mouth at an attachment end that meets a mouth of a collection vessel to form a flow path.

10. The collection vessel assembly of claim 1, wherein the vessel extender is fabricated from inert material that is not significantly hydroscopic.

11. The collection vessel assembly of claim 10, wherein the fabrication material includes plastic such as one of the following: polytetrafluoroethylene, polymer, polypropylene, polyethylene, or polyurethane.

12. A collection vessel assembly, comprising:
a collection vessel for collecting liquid phase from a chromatographic mobile phase flow stream;
a vessel extender, sealably attached to the collection vessel, such that the vessel extender and collection vessel form a flow path for the liquid phase to flow through the vessel extender and into the collection vessel,
wherein the vessel extender provides volumetric storage capacity for liquid phase beyond the volumetric capacity of the collection vessel.

16. A method for extending the volumetric capacity of a collection vessel in a chromatographic collection system, comprising:
forming an extended volumetric capacity for the collection vessel by attaching a vessel extender to a collection vessel such that liquid phase from a mobile phase flow stream flows through the vessel extender and into the collection vessel and holds overflow from the collection vessel; and
sealing an attachment between the collection vessel and the vessel extender to prevent leakage of liquid phase from the vessel extender.

17. The method of claim 16, wherein said attaching comprises externally coupling the collection vessel and the vessel extender together.

18. The method of claim 16, wherein said attaching comprises extending a mouth of the vessel extender into a mouth of the collection vessel.

19. The method of claim 16, further comprising:
holding the collection vessel in a housing; and
attaching the housing to the vessel extender such that the attachment end of the vessel extender meets an open mouth of the collection vessel to form a flow path.
